(19) United States
(12) Patent Application Publication
(10) Pub. No.: US 2010/0031270 A1
(43) Pub. Date: Feb. 4, 2010

(54) HEAP MANAGER FOR A MULTITASKING VIRTUAL MACHINE

(76) Inventors: Gansha Wu, Beijing (CN); Xin Zhou, Beijing (CN); Biao Chen, Beijing (CN); Peng Guo, Beijing (CN); Jinzhan Peng, Beijing (CN); Zhiwei Ying, Shanghai (CN)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/309,448

(22) PCT Filed: Aug. 1, 2006
(86) PCT No.: PCT/CN2006/001933

§ 371 Date: Sep. 18, 2009

(51) Int. Cl. G06F 9/46; G06F 9/455

(52) U.S. Cl. 718/107; 718/100; 718/1

(57) ABSTRACT

A multitasking virtual machine is described. The multitasking virtual machine may comprise an execution engine to concurrently execute a plurality of tasks. The multitasking virtual machine may further comprise a heap organization coupled to the execution engine. The heap organization may comprise a system heap to store system data accessible by the plurality of tasks; and a plurality of task heaps. Each of the plurality of task heaps may be assigned to each of the plurality of tasks to store task data accessible by the assigned task. The multitasking virtual machine may further comprise a heap manager to manage the heap organization. The heap manager may comprise a heap size controller to control heap size of the system heap.

### BACKGROUND

A heap organization is a memory area that may be used to store data for a plurality of tasks that are executed concurrently by a multitasking virtual machine. The data may include program objects and metadata for all of the tasks.

Conventionally, there are two classes of heap organization, shared heap and separated heap. For the shared heap class, the multitasking virtual machine may use a single heap to store data accessible by all of the tasks. For the separated heap class, the multitasking virtual machine may use a number of heaps that are logically separated. Each separated heap may be assigned to store the data that is only accessible by a single task.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a computing platform including a multi-tasking virtual machine.

FIG. 2 illustrates an embodiment of the multitasking virtual machine.

FIG. 3 illustrates an embodiment of a heap organization of the multitasking virtual machine.

FIG. 4 illustrates another embodiment of a heap organization of the multitasking virtual machine.

FIG. 5 illustrates still another embodiment of a heap organization of the multitasking virtual machine.

FIG. 6 illustrates an embodiment of a heap manager of the multitasking virtual machine.

FIG. 7 illustrates an embodiment of a method of controlling size of the heap organization.

FIG. 8 illustrates an embodiment of a method of garbage collecting a task heap of the heap organization.

FIG. 9 illustrates an embodiment of a method of suspending a task for garbage collection of the heap organization.

### DETAILED DESCRIPTION OF THE PREFERRED EMBODIMENTS

The following description describes techniques for heap manager for a multitasking virtual machine. In the following description, numerous specific details such as logic implementations, pseudo-code, mechanisms to specify operands, resource partitioning/sharing/duplication implementations, types and interrelationships of system components, and logic partitioning/integration choices are set forth in order to provide a more thorough understanding of the current invention. However, the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, that may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.) and others.

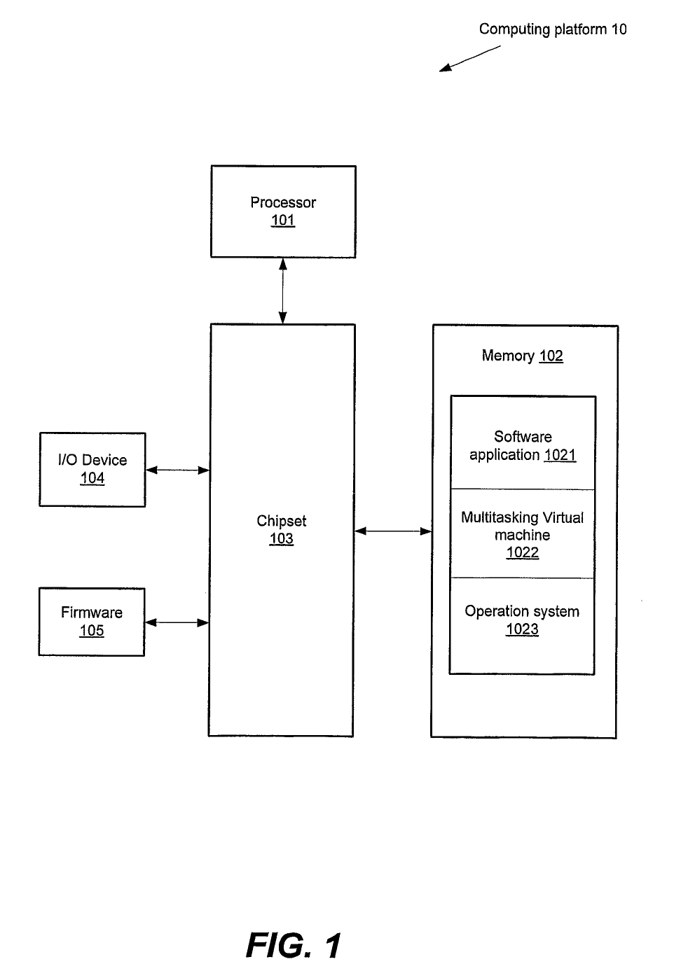

FIG. 1 shows an embodiment of a computing platform 10 comprising a multitasking virtual machine. Examples for the computing platform 10 may include a personal computer, a workstation, a server computer, a personal digital assistant (PDA), a mobile telephone, and a game console.

The computing platform 10 may comprise one or more processors 101, memory 102, chipset 103, I/O devices 104, a firmware 105 and possibly other components. The one or more processors 101 may be communicatively coupled to various components (e.g., the chipset 103) via one or more buses such as a processor bus. The processors 101 may be implemented as an integrated circuit (IC) with one or more processing cores that may execute codes under a suitable architecture, for example, including Intel® Xeon™, Intel® Pentium™, Intel® Itanium™ architectures, available from Intel Corporation of Santa Clara, Calif.

The memory 102 may store instructions and data in the form of a plurality of software applications 1021, a multitasking virtual machine 1022 and an operation system 1023. Examples for the memory 102 may comprise one or any combination of the following semiconductor devices, such as synchronous dynamic random access memory (SDRAM) devices, RAMBUS dynamic random access memory (RDRAM) devices, double data rate (DDR) memory devices, static random access memory (SRAM), and flash memory devices.

The plurality of software applications 1021 may be input from any suitable devices, such as the I/O devices 106. In other embodiments, the software applications may also be generated by other components within the computing platform 10. Examples for the software applications 1021 may comprise JAVA applications (e.g., JAVA.class files), .NET application (e.g., .NET codes), or applications in possibly other programming languages.

The multitasking virtual machine 1022 may run above the operating system 1023 to concurrently execute the plurality of software applications 1021. Each software application 1021 may include one or more tasks, each of which may represent an instantiation of a single software application 1021. In a JAVA virtual machine, if two ‘tasks’ share the same class path (i.e., same ordered table of the class files), the two ‘tasks’ may belong to one application.

Examples for the multitasking virtual machine 1022 may comprise a multitasking JAVA virtual machine available from Sun Microsystems Inc., Mountain View, Calif., and a multitasking NET virtual machine available from Microsoft® Corporation, Redmond, Wash. The operation system 1023 may include, but is not limited to, different versions of Linux®, Microsoft® Windows®, and real time operating systems such as VxWorks®, etc.

In an embodiment, the chipset 103 may provide one or more communicative paths among the one or more processors 101, memory 102 and other components, such as the I/O device 104 and firmware 105. Examples for the I/O devices 104 may comprise a keyboard, mouse, network interface, a storage device, a camera, a blue-tooth device, and an antenna. The firmware 105 may store BIOS routines that the computing platform executes during system startup in order to initialize the processors 101, chipset 103, and other components of the computing platform and/or EFI routines to interface the firmware 105 with an operating system of the computer platform and provide a standard environment for booting the operating system.

Other embodiments may implement other technologies for the structure of the computing platform 10. For example, the multitasking virtual machine 1022 may execute one software application 1021 in one instantiation of the virtual machine. In other words, the multitasking virtual machine 1022 may concurrently execute a plurality of tasks belonging to one application in one instantiation of the virtual machine, and the plurality of tasks are respectively instantiations of the application.

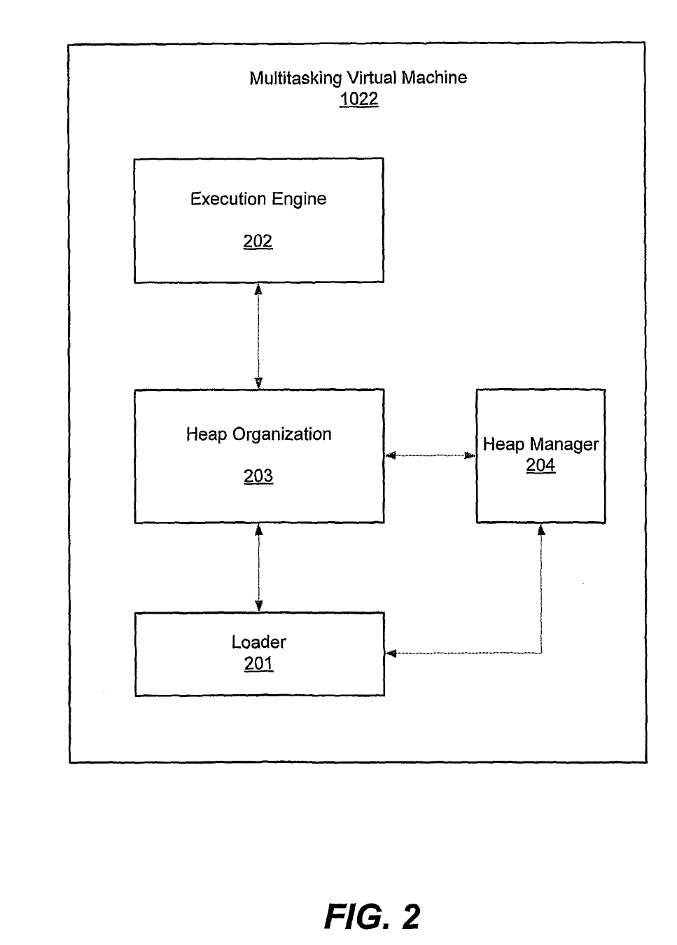

FIG. 2 shows an embodiment of the multitasking virtual machine 1022. According to the embodiment, the multitasking virtual machine 1022 may comprise a loader 201, an execution engine 202, a heap organization 203, a heap manager 204 and possibly other components.

The loader 201 may load files (including classes, interfaces, native methods) from various resources. For example, the loader 201 may load the plurality of software applications 1021, libraries, runtime environment variables and possibly other files from the multitasking virtual machine vendor, the programmer and any third parties. The libraries may comprise various functions or routines to provide basic functionalities to user programs, such as bootstrap class libraries and non-bootstrap class libraries. The runtime environment variables may comprise configurations to help the multitasking virtual machine find the application resources. Examples of the loader may comprise class loaders, native method interface, and possibly other loading mechanisms.

The execution engine 202 may concurrently execute a plurality of tasks associated with the software applications 1021. More specifically, the execution engine 202 may concurrently translate the software applications and execute the translated codes.

The heap organization 203 may store data for the multitasking virtual machine 1022, such as metadata and program objects. The metadata may comprise information about the files loaded from the loader 201 or other components (e.g., software applications, libraries, runtime environment variables, etc.), translated codes of the files from the execution engine 202 and possibly other data. Examples of the metadata may comprise virtual machine internal representation of JAVA classes, methods, fields, bytecodes, JIT'ed (Just-in-time) codes, and the like. The program objects may comprise objects generated when executing the loaded files. Examples of the program objects may comprise user-defined class loaders and instances of class files.

The heap manager 204 may manage the heap organization 203, such as loading data into the heap organization 203, reclaiming data from the heap organization 203, controlling size of the heap organization 203 and possibly other heap managements.

Other embodiments may implement other technologies for the structure of the multitasking virtual machine 1022.

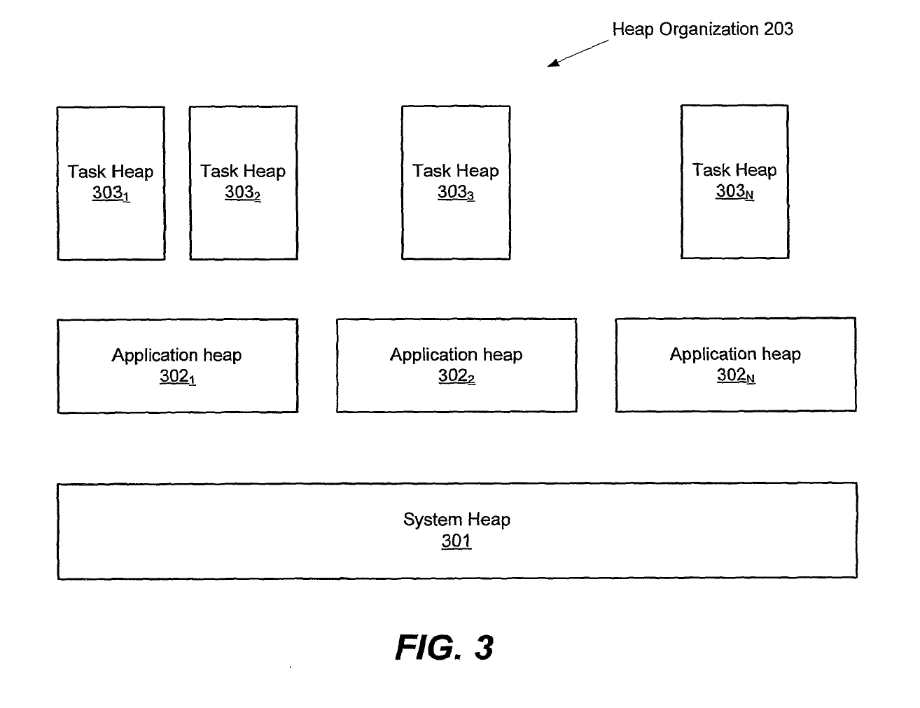

FIG. 3 shows an embodiment of the heap organization 203.

The heap organization 203 may comprise a plurality of logically disjointed heaps, wherein each heap may comprise a plurality of logically contiguous memory blocks and no blocks may overlap between two heaps.

In the embodiment of FIG. 3, the heap organization 203 may comprise a system heap 301, a plurality of application heaps 302₁, 302₂ . . . 302_{N} and a plurality of task heap 303₁, 303₂ . . . 303_{N}.

The system heap may store system data sharable for all of the tasks executed by the multitasking virtual machine 1022. Lifespan for the data stored in the system heap may be equal to one instantiation of the multitasking virtual machine 1022. Examples of the system data may comprise metadata of globally shared libraries (e.g., bootstrap class libraries, globally shared runtime environment, platform-definition information), program objects having a lifespan equal to the instantiation of the multitasking virtual machine (e.g., the objects generated when executing the bootstrap class program), and possibly other data for the system. In the embodiment of FIG. 3, the system heap 301 is a singleton and may not be subject to reclamations or even compaction.

The multitasking virtual machine 1022 may assign each of the application heaps 302 to each ‘live’ application of the plurality of the software applications 1021, in which a ‘live’ application may have at least one task that is executed by the multitasking virtual machine 1022. A task may be an instantiation of its application. Each of the application heaps 302 may store application data accessible by all of the task(s) belonging to the application and lasting as long as the application. For JAVA virtual machine specification, if two ‘tasks’ belong to one application, the two ‘tasks’ may share the same class path, namely, they may share the same ordered table of class files. In view of this, an application may represent executable binaries (including dynamically loaded binaries) and runtime environment for its tasks.

The application data stored in each of the application heaps 302 may comprise metadata for the application and program objects that may have the same lifespan as the application. Examples of the metadata for the application may comprise information about application class files, translated codes of the application class files, application libraries and runtime environment variables for translating and executing the application class files, and possibly other data for the application. Examples of the program objects may comprise the objects generated when initializing the application class files. In the embodiment of FIG. 3, the multitasking virtual machine 1022 may reclaim the application heap if the last task of the application is terminated.

The multitasking virtual machine 1022 may assign each of the task heaps 303 to each ‘live’ task executed by the multitasking virtual machine 1022. Each of the task heaps 303_{1-N} may store task data only accessible by the associated task, which means accessing of the task data by other tasks may be prohibited. The task data may have the same lifespan as the associated task. Examples of the task data may comprise program objects generated when executing the task and runtime environment variables for executing the task. In the embodiment of FIG. 3, the multitasking virtual machine 1022 may reclaim the task heap if the associated task is terminated.

As shown in FIG. 3, a task may access the task data stored in its task heap and the system data stored in the system heap. The task may further access the application data stored in the application heap for the application that the task may belong to. Since one application may have more than one tasks being executed by the multitasking virtual machine 1022, one application heap may have more than one task heaps bound therewith. For example, application heap 302₁ may have two task heaps 303₁-303₂ bound therewith. However, the task can not access other application data stored in other application heaps for other applications that the task may not belong to.

Other embodiments may implement other technologies for the structure of the heap organization 203 of FIG. 3. For example, if the multitasking virtual machine 1022 executes one application 1023 during one instance, the heap organization 203 may comprise a system heap to store system data and application data, and a plurality of task heap to store task data.

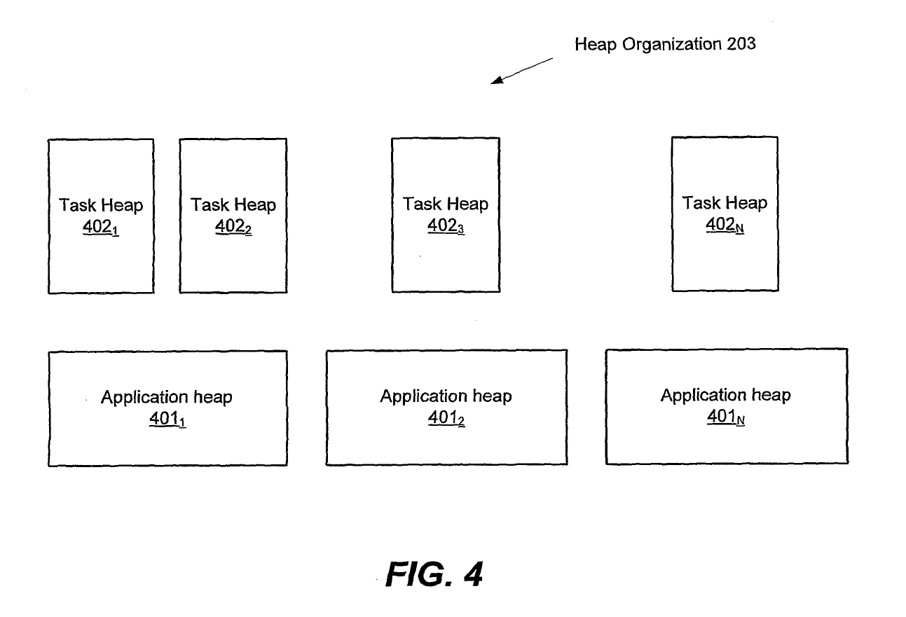

FIG. 4 shows another embodiment of the heap organization 203.

The heap organization 203 may comprise a plurality of application heaps 401₁, 401₂ . . . 401_{N} and a plurality of task heaps 402₁, 402₂ . . . 402_{N}. The multitasking virtual machine 1022 may assign each of the application heaps 401 to each of the applications 1021. Each application heap may comprise system data and application data only accessible by the task(s) belonging to the application and lasting as long as the application. The system data may comprise metadata and program objects of globally shared libraries and globally shared runtime environment, and the application data may comprise metadata and program objects of the application classes, application libraries and application runtime environment.

The multitasking virtual machine 1022 may assign each of the task heaps 402 to each task executed by the multitasking virtual machine. Each task heap may store task data only accessible by the associated task and lasting as long as the associated task. The task data may comprise program objects and runtime environment for the task. Each of the task heaps 402 may be bound to one of the application heaps 401, so that the task can access the data in the task heap as well as the application task.

Other embodiments may implement other technologies for the structure of the heap organization of FIG. 4. For example, the multitasking virtual machine 1022 may copy the system data into each task heap 402, but not into each application heap 401.

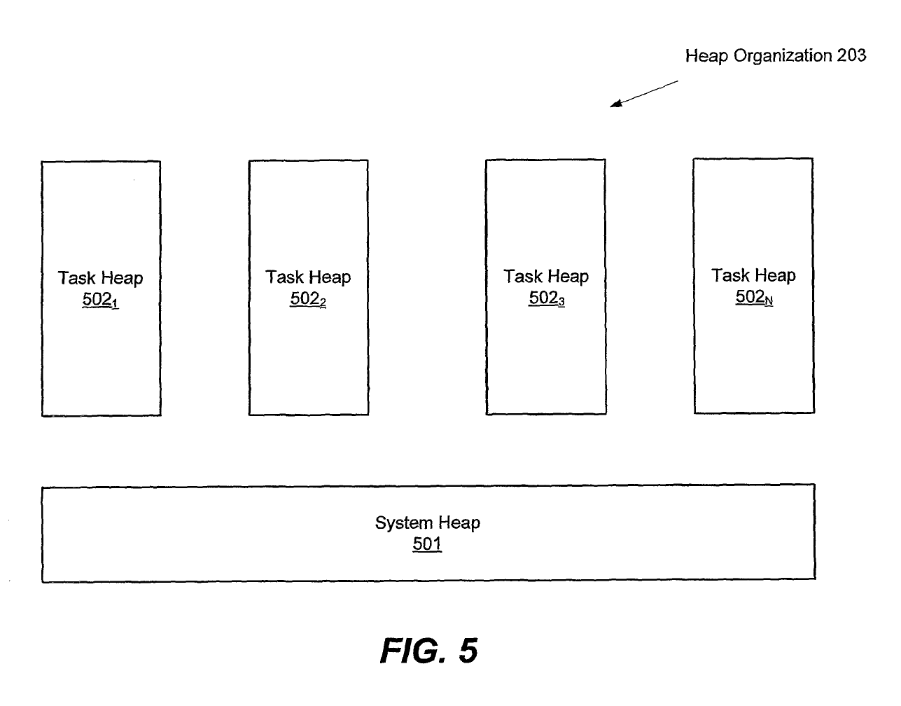

FIG. 5 shows still another embodiment of the heap organization 203.

As shown, the heap organization 203 may comprise a system heap 501 and a plurality of task heaps 502₁, 502₂ . . . 502_{N}. The system heap 501 may store system data accessibly by all of the tasks executed by the multitasking virtual machine 1022 and lasting as long as an instantiation of the multitasking virtual machine 1022. The system data may comprise metadata for globally shared libraries and globally shared runtime environment variables, and program objects that may last as long as the instantiation of the multitasking virtual machine, and possibly other system data.

The multitasking virtual machine 1022 may assign each of the task heaps 502 to each task executed by the multitasking virtual machine 1022. Each task heap may store application data and task data only accessible by the associated task. The application data may comprise metadata and program objects for the application classes, application libraries and runtime environment, and possibly other data for the application. The task data may comprise program objects and runtime environment variables for the task.

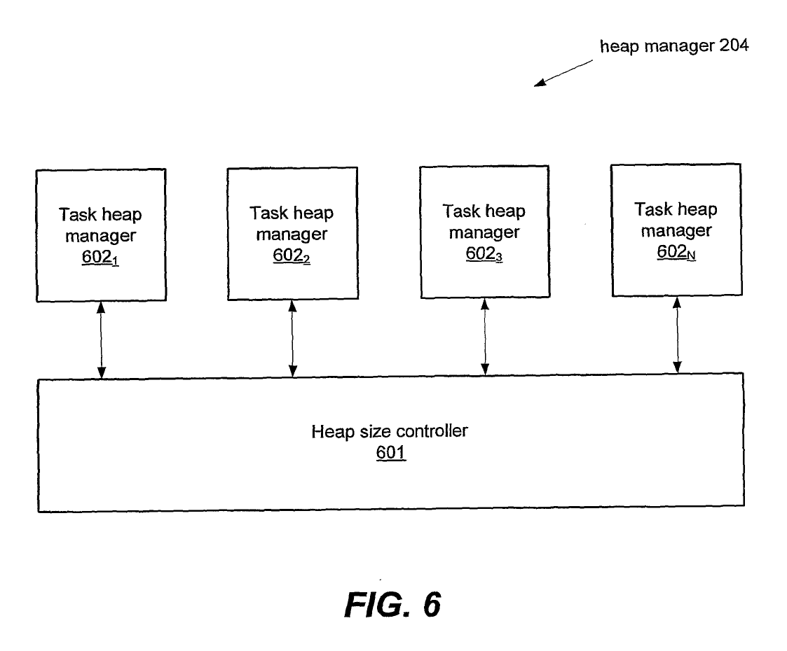

FIG. 6 shows an embodiment of the heap manager 204 of the multitasking virtual machine 1022.

As shown, the heap manger 204 may comprise a heap size controller 601 and a plurality of task heap managers 602₁, 602₂ . . . 602_{N}.

The heap size controller 601 may be responsible for controlling size of the plurality of heaps of the heap organization 203, such as the system heap, application heaps and task heaps. The heap size controller 601 may further be responsible for reclaiming the application heap and/or the task heap when the corresponding application or task exits. The heap size controller 601 may take various measures to control the size of the heap organization 203. For example, the heap size controller 601 may determine upper size bound for each heap in the heap organization 203 and transfer extra data that can not be accommodated by a heap of a certain layer (e.g., system layer, application layer) due to the size limitation to another heap of a lower layer (i.e., the layer lower than the certain layer, such as application layer, task layer) whose task(s) may use the extra data, such as transferring extra system data to an application heap or a task heap, or transferring extra application data to a task heap.

For another example, the heap size controller 601 may grow a heap of a certain layer (e.g., system layer, application layer) over its upper bound while shrinking heap(s) of a lower layer (e.g., application layer, task layer) bound with the grown heap in order to balance the heap space, e.g., growing a system heap while shrinking the application heaps or task heaps bound with the system heap, or growing an application heap while shrinking the task heaps bound with the application heap. For still another example, the heap size controller 601 may adjust the upper size bound for a certain heap, e.g., raise the upper bound for a task heap if there is high demand of data storage into this task heap.

However, the heap size controller 601 may have to terminate a task and/or an application if receiving a notification of denial of service (DoS). For yet another example, the heap size controller 601 may control the data eligible to be stored in a shared heap, such as the system heap or the application heap. For instance, the heap size controller 601 may control to store the system data or application data of a usage frequency over a certain threshold into the system heap or the application heap and store other system data or application data into the application heaps or task heaps whose task(s) may use the data.

The multitasking virtual machine 1022 may assign each of the task heap managers 602₁, 602₂ . . . 602_{N} to each of the task heaps (e.g., task heaps 303, task heaps 402, and task heaps 502) and manage the assigned task heap. For example, the task heap manager 602 may manage memory allocation and memory reclamation of the task heap, such as multi-blocks compaction, garbage collection, block fragmentation, reference patch, and possibly other heap management. Examples of the task heap manager 602 may comprise a garbage collector equipped with full-fledged heap states and management facilities for its task heap. Examples of the heap states may comprise list of free blocks in the task heap, list of allocating blocks in the task heap and the list of used blocks in the task heap. Examples of the management facilities may comprise function of allocating objects into the task heap, function of marking ‘live’ objects in the task heap and function of walking through all of the ‘live’ objects in the task heap. The multitasking virtual machine 1022 may further equip the task heap manager 602 with finalizer threads and queues for its task so that the task heap manager may reclaim objects from the task heap with finalize methods without considering unintentional interference from other tasks.

Further, the multitasking virtual machine 1022 may assign different types of the task heap managers 602 to the task heaps for the tasks with different characterizations. For example, the multitasking virtual machine 1022 may assign an incremental or concurrent garbage collector to a task heap for a user interface task that may require active garbage collection, while the multitasking virtual machine 1022 may assign a generational or mark-sweep garbage collector to a task heap for a throughput task that may require less frequent garbage collections.

For garbage collection, each task heap manager 602 may keep a disjoint root set for its task heap wherein the root set may comprise roots through which ‘live’ data stored in the task heap may be reachable so that the task heap manager 602 may perform the garbage collection by only keeping the ‘live’ data in the task heap and removing the ‘dead’ data (i.e., the data that is not reachable through the roots) from the task heap. The roots in the root set may comprise references to ‘live’ data stored in the task heap. The multitasking virtual machine 1022 may store the references in a task-specific state, task-private thread stack and possibly other data structure in the task heap.

Since the heap organization 203 as shown in FIG. 3, 4 or 5 comprises the plurality of heaps (e.g., system heap, application heap, and task heaps) and one task may be bound with more than one heaps of the heap organization 203 to access data in those heaps (e.g., the data in its task heap, application heap and the system heap), the roots may further comprise references from the system heap and/or application heap to the task heap or from the task heap to the system heap and/or application heap, which may be called as cross-heap references. For example, each class representation maintains a table of per-task class states, namely, Isolate Class State (ICS). The table may reside in the system heap or application heap, while the ICS may be allocated in each task's task heap, which may result in a cross-heap reference from the system heap or application heap to the task heap. For another example, each object in the task heap may comprise an object header having a pointer to its class representation in the system heap or application heap, which may result in another cross-heap reference from the task heap to the system heap or application heap.

The cross-heap references may also be useful when the task heap manager reclaim the corresponding task heap. For example, the task heap manager may revoke the cross-heap references in order to reclaim the task heap.

The cross-heap references may further comprise references from an application heap to the system heap. For example, a class representation in the application heap may have a pointer to its super class' representation in the system heap. Therefore, when the heap manager 204 reclaims the application heap, the heap manager 204 may revoke all of the cross-heap references from the application heap to the system heap.

In the embodiment of FIG. 6, the task heap manager may further suspend the task corresponding to the task heap for heap management without interference to other tasks. The task heap manager may desire to perform the heap management (e.g., garbage collection of the task heap) when each thread of the task stops at each thread's heap management point (e.g., garbage collection point), wherein different threads may have different heap management points.

Several methods may be applied for the task heap manager to make sure that all of the threads of the task suspend at their respective heap management points, such as polling method and code patching method. The code patching method may first suspend all of the threads of the task at a suspension point, check any thread whose heap management point happens after the suspension point, and dynamically patch codes of the checked thread to suspend itself when reaches its heap management point.

Since the heap organization 203 as depicted in FIG. 3, 4 or 5 stores codes sharable by two or more tasks into the system heap and/or application heap (e.g., shared executable binaries and runtime environment variables in the application heap), the task heap manager may need to make sure that patching codes for one task may not interfere other tasks. Therefore, the task heap manager may copy the related codes into a storage for the task, for example, copy codes of a thread of the task starting from the suspension point to the thread's heap management point into the task heap for the task. Then, the task heap manager may patch the copied codes, transfer execution of the thread to the copied codes and wait for the thread to suspend itself, so that the task heap manager may perform the heap management. After completion of the heap management, the execution right of the thread may be transferred back to the shared codes in the system heap and/or the application heap.

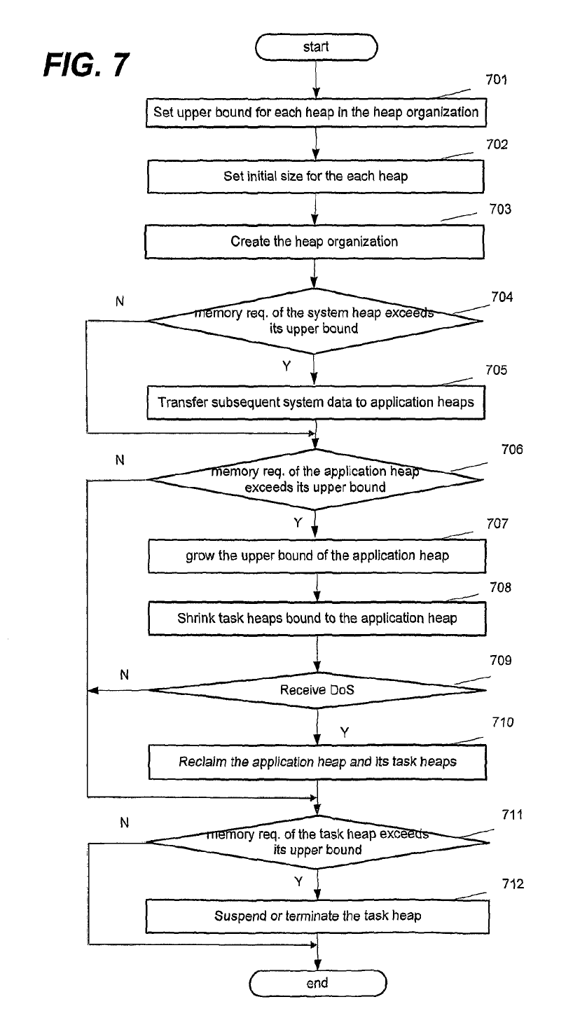

FIG. 7 shows an embodiment of a method of controlling size of the heap organization 203. In block 701, the heap manager 204 may set upper size bound for each heap in the heap organization, such as upper bound for the system heap 301, each of the application heaps 302 and each of the task heaps 303. The heap manager 204 may determine the upper bound according to heuristics. In block 702, the heap manager 204 may set an initial size for each heap in the heap organization 203. Then, in block 703, the heap manager 204 may help to create the heap organization 203 with each heap in the heap organization 203 started on its predetermined initial size.

In block 704, the heap manager 204 may determine whether memory requirement of the system heap 301 exceeds its upper bound. Such situation may happen when a lot of system data are piled into the system heap. In order to control the size of the system heap 301, the heap manager 204 may further determine that frequently used system data (e.g., the system data of usage frequency over a predetermined threshold) may be eligible to be stored into the system heap 301 and other system data (e.g., less frequently used system data, or the system data of usage frequency below the predetermined threshold) may be transferred into one or more application heaps 302 or even one or more task heaps 303 whose task(s) may or may not use the system data. The heap manager 203 may determine the eligible system data stored in the system heap based on heuristics, offline profiling or online profiling.

In response to determining that the memory requirement of the system heap 301 does not exceeds its upper bound, the heap manager 204 may further determine whether memory requirement of an application heap and/or a task heap exceeds the corresponding upper bound. However, in response to determining that the memory requirement of the system heap 301 exceeds its upper bound, the heap manager 204 may transfer the subsequent system data into one or more application heaps 302 or task heaps 303 whose tasks may or may not use the data in block 705. It should be appreciated that other technologies may be adopted to control size of the system heap 301. For example, the heap manager 204 may raise the upper bound if the memory requirement of the system heap 301 over its limitation.

In block 706, the heap manager 204 may determine whether memory requirement of an application heap exceeds its upper bound. Such situation may happen when a lot of application data and/or system data are piled in the application heap. If the memory requirement of the application heap does not exceed the upper bound, the heap manager 204 may further determine whether the memory requirement of a task heap exceeds its upper bound. However, if the memory requirement of the application heap exceeds the upper bound, the heap manager 204 may grow the application heap over its upper bound in block 707 and shrink the task heap(s) bound with the application heap accordingly to compensate the memory space overcharged by the grown application heap in block 708. For example, if the application heap 302₁ grows N extra bytes, then the heap manager 204 may charge the task heaps bound to the application heap with N/2 bytes each.

Then, the heap manager 204 or other suitable device may determine whether receiving a notification of denial of service (DoS) in block 709. Such notification may happen when the task heap is shrunk so much that may influence performance of the corresponding task. In response to receiving the DoS notification, the heap manager 204 may reclaim the application heap as well as all of the bound task heap(s) in block 710. However, it should be appreciated that other technologies may be adopted to control the size of the application heap. For example, the heap manager 204 may remain the application heap but advise one or more tasks bound with the application heap to exit or raise upper bound of the application heap in response to the DoS attack.

In block 711, the heap manager may determine whether memory requirement of a task heap exceeds its upper bound. If exceeds the upper bound, the task manager may suspend or terminate the task corresponding to the task heap to avoid DoS attack in block 712. However, the heap manager 204 may take other measures to control the size of the task heap. For example, the heap manager 204 may raise the upper bound for the task heap.

Other embodiments may implement other technologies of the method of FIG. 7. In an embodiment, the method may be applicable for the heap organization of other structures, such as the heap organization of FIG. 4 or 5. In another embodiment, the heap manger 204 (e.g., the heap size controller or the task heap manager of the heap manager) may further grow or shrink a task heap according to the memory usage overall and running characteristics of the corresponding task. For example, if the task desires to defer or avoid garbage collection which may happen for a throughput task, the heap manager 204 may grow the task heap to reduce frequency of the garbage collections or increase latency of a neighborhood garbage collection. If the task desires a more responsive or active garbage collection which may happen for a user-interface or interactive task, the heap manager 204 may shrink the task heap to reduce response time of each garbage collection or increase the frequency of the garbage collections.

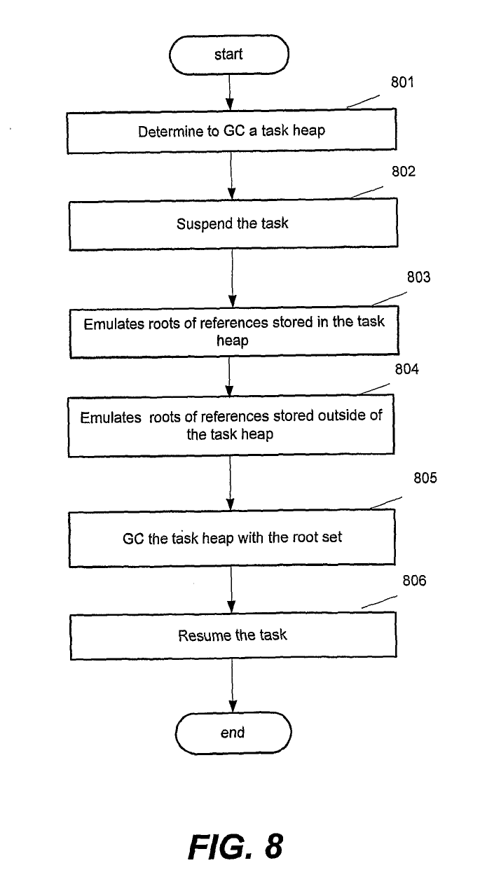

FIG. 8 shows an embodiment of a method of garbage collecting a task heap of the heap organization 203.

In block 801, a task heap manager for the task heap may determine to collect data no longer needed from a task heap of the heap organization 203 (e.g., task heaps 303, task heaps 402, and task heaps 502). The task heap manager may make such decision under various conditions (e.g., when the task heap is out of space) or on regular basis. In block 802, the task heap manager may suspend the task corresponding to the task heap. Many methods may be applied for the task suspension, such as polling and code patching.

Then, the task heap manager may enumerate roots of references referring to ‘live’ data stored in the task heap and create a root set for the task heap. The references may be stored in various places. Therefore, the task heap manager may enumerate roots of the references stored in the task heap in block 803. The references may be stored in the task-specific state, task-private stack and possibly other data structure in the task heap. Then, in block 804, the task heap manager may enumerate roots of the references stored outside of the task heap. For example, the task heap manager may scan the application heap and/or system heap which the task heap may be bound with to enumerate the references from the application heap and/or the system heap to the task heap, i.e., the so-called cross-heap references. In block 805, the task heap manager may perform the garbage collection of the task heap based upon the root set. For example, the task heap manager may keep the data referred by the references of the root set (i.e., ‘live’ data) in the task heap and discard the un-referred data (i.e., ‘dead’ data) from the task heap. In block 806, the task heap manager may resume the task.

Other embodiments may implement other technologies for the method of garbage collecting the task heap. For example, the task heap manager may maintain a bitmap for cross-heap references, wherein each bit of the bitmap may correspond to one word and value ‘1’ or ‘0’ of the each bit may represent whether the corresponding word stores a cross-heap reference or not. The task heap manager may fast scan the bitmap to pick up all the words that may store the cross-heap references.

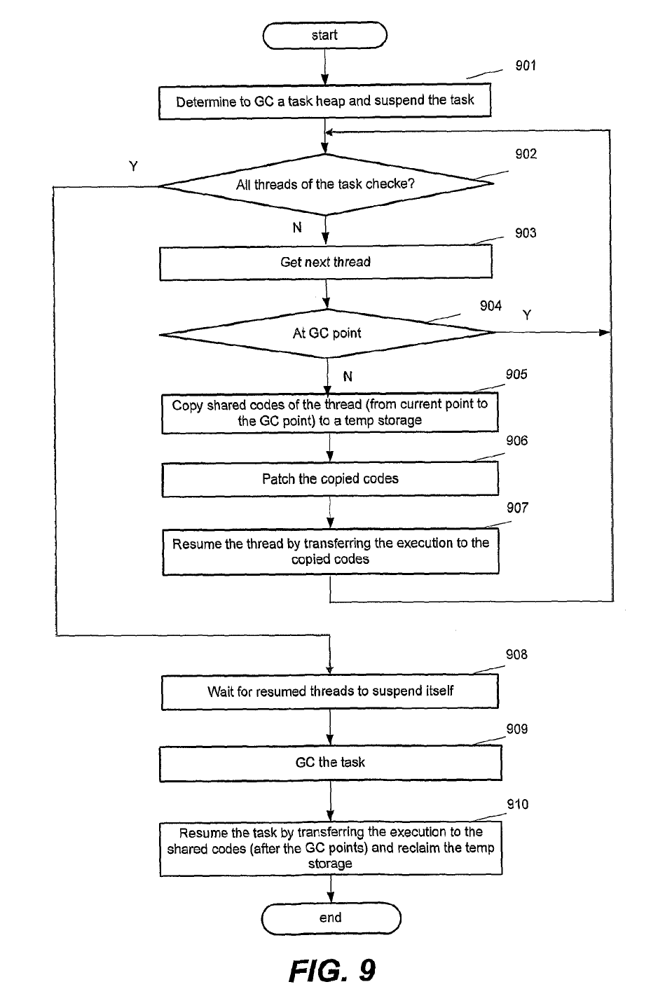

FIG. 9 shows an embodiment of a method of suspending a task for garbage collection of a task heap in the heap organization 203.

In block 901, a task heap manager for a task heap of the heap organization 203 may determine to collect data that is no longer needed from the task heap (e.g., task heaps 303, task heaps 402, and task heaps 502). Meanwhile, the task heap manager may suspend the task corresponding to the task heap at a suspension point. The suspension point may be or may not be a garbage collection point for one or more threads of the task. Each thread of the task may have a garbage collection point that may be or may not be different from other threads’. The garbage collection point for a thread may be represented by an instruction of the thread at which the task may suspend itself so that the task heap manager may perform accurate garbage collection.

In the following blocks 902-907, the task heap manager or other suitable device (e.g., a JIT compiler) may check each thread of the task to determine whether the suspension point, at which the task has been suspended, is the each thread's garbage collection point and patch codes for any thread whose garbage collection point is different from the suspension point. In particular, the task heap manager or other suitable device may determine whether all of the threads of the task have been checked in block 902 and get a next thread for check in response that not all of the threads have been checked in block 903.

In block 904, the task heap manager or other suitable device may check whether the suspension point is the next thread's garbage collection point. If yes, the task heap manager or other suitable device may return to block 902 and continue to determine whether all of the threads of the task have been checked. If no, the task heap manager or other suitable device may copy related codes of the thread from a shared heap to a storage for the task in block 905. The related codes may comprise task's executable binaries and runtime environment (including libraries and variables) that may start from the suspension point, at which the task has been suspended, until the task's garbage collection point that may happen subsequently to the suspension point. The shared heap may comprise the system heap and/or the application heap whose data may be sharable by the task to be garbage collected and other task(s) not to be garbage collected. The storage for the task may comprise the task heap or possibly other memory area to store the codes for the task.

In block 906, the task heap manager or other suitable device may patch the copied codes in the storage for the task so that the thread may suspend itself at its garbage collection point. Then, in block 907, the task heap manager or other suitable device may resume the thread by transferring execution right of the thread from the shared coded in the share heap to the patched codes in the storage for the task.

In response that all of the threads of the task have been checked, the task heap manager may wait until all of the threads suspend at their garbage collection points. Then, the task heap manager may garbage collect the task heap in block 909 and resume the task after the garbage collection by transferring the execution right of the task from the patched codes in the storage for the task to the shared codes in the shared heap.

Other embodiments may implement other technologies for the method of FIG. 9. For example, the task heap manager or other suitable device may copy shared codes of all of the threads of the task that are subsequent to the suspension point from the shared heap to the data storage, so that the task may be resumed after garbage collection by executing the codes in the data storage. For another example, the above-described method may be applicable for other purposes that may need to suspend a task without interfering other tasks.

Although the present invention has been described in conjunction with certain embodiments, it shall be understood that modifications and variations may be resorted to without departing from the spirit and scope of the invention as those skilled in the art readily understand. Such modifications and variations are considered to be within the scope of the invention and the appended claims.

What is claimed is:

1. A multitasking virtual machine, comprising:
an execution engine to concurrently execute a plurality of tasks;
a heap organization coupled to the execution engine, wherein the heap organization comprises:
a system heap to store system data accessible by the plurality of tasks; and
a plurality of task heaps, each of the plurality of task heaps assigned to each of the plurality of tasks to store task data accessible by the assigned task; and
a heap manager to manage the heap organization, comprising a heap size controller to control heap size of the system heap.

2. The multitasking virtual machine of claim 1, wherein the heap size controller further stores the system data used beyond a predetermined frequency threshold into the system heap.

3. The multitasking virtual machine of claim 1, wherein the heap size controller further:
sets a first upper size bound for the system heap; and
transfers a part of the system data to a task heap of the plurality of task heaps if memory requirement of the system heap exceeds the first upper size bound.

4. The multitasking virtual machine of claim 1, wherein the heap size controller further:
grows a tack heap of the plurality of task heaps in response to a request to decrease frequency of garbage collections; and
shrinks the task heap in response to a request to increase frequency of garbage collection.

5. The multitasking virtual machine of claim 1, wherein the heap organization further comprises an application heap assigned to an application to store application data for the application, wherein the application data is accessible by at least one task of the plurality of tasks that is associated with the application.

6. The multitasking virtual machine of claim 5, wherein the heap size controller further:
sets a first upper size bound for the system heap; and
transfers a part of the system data to the application heap if memory requirement of the system heap exceeds the first upper size bound.

7. The multitasking virtual machine of claim 5, wherein the heap size controller further:
sets a second upper size bound for the application heap;
grows the application heap over the second upper size bound if memory requirement of the application heap exceeds the second upper size bound; and
shrinks at least one of the plurality of task heaps assigned to the at least one task associated with the application to compensate a memory space overcharged due to the growth of the application heap.

8. The multitasking virtual machine of claim 1, further comprising:
a plurality of task heap managers, each task heap manager assigned to the each task heap and responsible for heap management of the each task heap.

9. The multitasking virtual machine of claim 8, wherein a task heap manager of the plurality of task heap managers further reclaims the task data no longer needed from the assigned task heap by collecting first references stored in the application heap that refer to the task data stored in the task heap.

10. The multitasking virtual machine of claim 8, wherein a task heap manager of the plurality of task heap managers further reclaims the task data no longer needed from the assigned task heap by collecting second references stored in the system heap that refer to the task data stored in the task heap.

11. A multitasking virtual machine, comprising:
an execution engine to concurrently execute a plurality of tasks;
a heap organization coupled to the execution engine, wherein the heap organization comprises a plurality of task heaps, each of the plurality of task heaps assigned to each of the plurality of tasks to store task data accessible by the assigned task; and
a heap manager to manage the heap organization, wherein the heap manager comprises a plurality of task heap managers, each task heap manager assigned to the each task heap to manage the assigned task heap.

12. The multitasking virtual machine of claim 11, wherein the heap organization further comprises an application heap assigned to an application to store application data accessible by at least one task of the plurality of tasks, wherein the at least one task is associated with the application.

13. The multitasking virtual machine of claim 12, wherein a task heap manager of the plurality of task heap managers further reclaims the task data no longer needed from the assigned task heap by collecting first references stored in the application heap that refer to the task data stored in the assigned task heap.

14. The multitasking virtual machine of claim 12, wherein a task heap manager of the plurality of task heap manager further reclaims the assigned task heap by collecting second references stored in the task heap that refer to the application data stored in the application heap.

15. The multitasking virtual machine of claim 12, wherein a task heap manager of the plurality of task heap further:
suspends a task at a suspension point, wherein a task heap of the task has been assigned with the task heap manager;
determines a thread of the suspended task whose garbage collection point is different from the suspension point; and
copies the application data related to the thread of the suspended task from the application heap to a memory region for the suspended task.

16. The multitasking virtual machine of claim 15, wherein the application data related to the thread comprises thread codes starting from the suspension point until the garbage collection point.

17. The multitasking virtual machine of claim 15, wherein the task heap manager further:
patches the application data in the memory region to suspend the thread at the garbage collection point;
resumes the thread by executing the patched application data in the memory region; and
reclaims the task data no longer needed from the task heap when the thread suspends at the garbage collection point.

18. The multitasking virtual machine of claim 15, wherein the task heap manager further:
resumes the suspended task by executing the application date related to the suspended task in the application heap.

19. The multitasking virtual machine of claim 12, wherein the heap manager further comprises a heap size manager to control size of the application heap.

20. The multitasking virtual machine of claim 19, wherein the heap size manager further:
sets an upper size bound for the application heap;
grows the application heap over the upper size bound if memory requirement of the application heap exceeds the upper size bound; and
shrinks at least one of the plurality of task heaps assigned to the at least one task associated with the application to compensate a memory space overcharged due to the growth of the application heap.

21. A method of a multitasking virtual machine, comprising:
storing system data accessible by a plurality of tasks into a system heap of the multitasking virtual machine;
storing task data for each of the plurality of tasks into each of a plurality of task heaps of the multitasking virtual machine, wherein the each task heap is assigned to the each task and stores the task data accessible by the assigned task; and
controlling size of the system heap.

22. The method of claim 21, wherein the controlling further comprises:
storing the system data used beyond a predetermined frequency threshold into the system heap.

23. The method of claim 21, wherein the controlling further comprises:
setting a first upper size bound for the system heap;
transferring a part of the system data into a task heap of the plurality of task heaps if memory requirement of the system heap exceeds the first upper size bound.

24. The method of claim 21, further comprising:
growing a task heap of the plurality of task heaps in response to a request to decrease frequency of garbage collections; and
shrinking the task heap in response to a request to increase frequency of the garbage collections.

25. The method of claim 21, further comprising:
storing application data for an application into an application heap, wherein the application data is accessible by at least one task of the plurality of tasks that associated with the application.

26. The method of claim 25, wherein the controlling further comprises:
setting a first upper size bound for the system heap;
transfer a part of the system data to the application heap if memory requirement of the system heap exceeds the first upper size bound.

27. The method of claim 25, further comprising:
setting a second upper size bound for the application heap;
growing the application heap over the second upper size bound if memory requirement of the application heap exceeds the second upper size bound; and
shrinking at least one of the plurality of task heaps assigned the at least one task associated with the application to compensate a memory space overcharged due to the growth of the application heap.

28. The method of claim 21, further comprising:
collecting references referring to the task data in a task heap of the plurality of task heaps, the references including first references residing in the system heap; and
removing the task data not referred by the collected references from the task heap.

29. The method of claim 21, further comprising:
collecting references referring to the task data in a task heap of the plurality of task heaps, the references including second references residing in the application heap; and
removing the task data not referred by the collected references from the task heap.

30. A machine-readable medium comprising a plurality of instructions which when executed result in a multitasking virtual machine:
suspending a task of a plurality of tasks at a suspension point;
copying application data for a thread of the suspended task from an application heap assigned to an application into a memory region assigned to the suspended task, wherein the application data stored in the application heap are accessible by more than one tasks of the plurality of tasks that are associated with the application and comprise the suspended task.

31. The method of claim 30, wherein the plurality of instructions further result in the multitasking virtual machine:
selecting the thread from a plurality of threads of the suspended task, wherein a garbage collection point of the thread is different from the suspension point.

32. The machine-readable medium of claim 30, wherein the plurality of instructions that result in the multitasking virtual machine copying, further result in the multitasking virtual machine:
copying the application data for the thread from the application heap to the memory region, wherein the application data comprises thread codes start from the suspension point until a garbage collection point of the thread.

33. The machine-readable medium of claim 30, wherein the plurality of instructions further result in the multitasking virtual machine:
patching the application data stored in the memory region to suspend the thread at a garbage collection point subsequent to the suspension point.

34. The machine-readable medium of claim 30, wherein the plurality of instructions further result in the multitasking virtual machine:
resuming the thread by transferring execution right of the application data from the application heap to the memory region; and
garbage collecting a task heap assigned to the suspended task after the thread suspends at a garbage collection point subsequent to the suspension point, wherein the task heap stores task data accessible by the suspended task.

35. The machine-readable medium of claim 30, wherein the plurality of instructions further result in the multitasking virtual machine:
resuming the task by transferring execution right of the application data from the memory region to the application heap.
